(19) United States
(12) Patent Application Publication
(10) Pub. No.: US 2007/0289905 A1
(43) Pub. Date: Dec. 20, 2007

(54) SYSTEM FOR MANAGING SOLUTION FOR CLEANING FERMENTATION TANKS

(75) Inventor: Sidney D. Sondag, Eden Prairie, MN (US)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(73) Assignee: BioFuels Automation, Inc.

(21) Appl. No.: 11/765,187

(22) Filed: Jun. 19, 2007

Related U.S. Application Data
(60) Provisional application No. 60/805,291, filed on Jun. 20, 2006.

(51) Int. Cl. B08B 3/00; C02F 1/00

(52) U.S. Cl. 210/97; 134/58 R; 134/111; 134/110; 210/167.01

(57) ABSTRACT

A system is useful for reconstituting cleaning solution of the type comprising a solution of a cleaning agent and water intended for cleaning fermentation tanks in an ethanol production facility. The cleaning solution is pumped into a fermentation tank after the fermentation liquids resulting from completion of a fermentation stage are removed, and before a new fermentation stage begins. The system comprises a tank for holding cleaning solution. The tank has a cleaning solution inlet port and an outlet port. A pump has an inlet port and an outlet port, with the inlet port in fluid communication with the tank's outlet port. A filter has an inlet port in fluid communication with the pump's outlet port, and an outlet port in fluid communication with the tank's cleaning solution inlet port. A sensor element is in fluid communication with the filter's outlet port. The sensor providing a condition signal indicating the concentration of the cleaning agent in the cleaning solution at the filter's outlet port. When the pump operates, the cleaning solution circulates through the filter to remove contaminants that affect the performance of the cleaning solution. This system can be configured with a controller that receives the condition signal and controls a valve that regulates flow of concentrated cleaning agent to the tank based on the condition signal.

### CROSS-REFERENCE TO RELATED APPLICATIONS

This is a regular application filed under 35 U.S.C. § 111(a) claiming priority, under 35 U.S.C. § 119(e)(1), of provisional application Ser. No. 60/805,291, previously filed Jun. 20, 2006 under 35 U.S.C. § 111(b).

### BACKGROUND OF THE INVENTION

One approach to at least partially solving the nation's automobile fuel problems has been the development of ethanol as a replacement for at least some of the gasoline that is burned in automobiles. At the present time ethanol is produced by fermentation of processed kernel corn.

Although not a part of this invention, it is helpful to know a little about the ethanol production process. Typically, before fermentation, corn is ground and then mixed with water containing a dissolved enzyme to form a mash. The enzyme converts the starches to sugars in the mash. This is important since much of the energy content of corn is contained in the starches, and starches do not ferment.

Adding yeast to the mash initiates fermentation of the sugars in the mash. The fermentation process produces the “beer”. After fermentation is complete, distillation of the “beer” yields alcohol and separates the mash solids. At least some of the remainder has value as animal feed or fertilizer.

After the fermented mash is removed from the fermentation tank, the tank must be cleaned to prepare for the next fermentation cycle. Typically, this cleaning process involves first isolating the fermentation tank from both the upstream mash source and from the downstream distillation equipment by appropriately setting flow control valves.

Then, a pump circulates cleaning solution typically comprising a diluted solution of sodium hydroxide (NaOH) through the fermentation tank and the components of the system between the fermentation tank and the distillation equipment. The preferred cleaning solution has a NaOH concentration of around 4.5% NaOH by weight in water and a temperature typically around 185° F.

The fermentation tank has orifices through which the pump forces cleaning solution at relatively high pressure. Once the cleaning solution has circulated for a time, the operator changes valve settings to allow as much of the cleaning solution as possible to be pumped out of the fermentation tank and other components. Then the tank and the other components are rinsed with fresh water to remove most of the cleaning solution.

A typical ethanol plant has two or more groups of fermentation tanks. While one or more groups contain fermenting corn, the other or others are undergoing cleaning preparatory to the next fermentation cycle for them.

Because of the large size of a typical ethanol plant, a large volume of cleaning solution is required. In the past, the cleaning solution was simply discarded after a single use. This is no longer acceptable because of environmental and cost issues. The practice now is to reconstitute the cleaning solution by adding NaOH to reset the concentration to the desired 4.5%.

It turns out that accurately setting the NaOH concentration in the cleaning solution is quite important. If the solution is too weak, the old fermentation products remaining in the fermentation tank are not completely deactivated and removed. If too strong, the caustic cleaning solution can harm the equipment. NaOH concentration of 4.5% seems to provide adequate cleaning and minimizes harm to the equipment.

The process now is to measure the NaOH concentration one way or another and then add either water or concentrated NaOH to the cleaning solution in an amount depending on the operator's judgment. To accurately reach the desirable 4.5% NaOH concentration, it is important to accurately measure NaOH concentration. Inaccurately measuring NaOH concentration prevents accurately setting the cleaning solution NaOH concentration.

A further problem with this procedure is that of the operator's judgment. If the operator misjudges the amount of water or NaOH concentrate to add, then the reconstitution procedure slows. And too, the procedure requires constant human attention.

There are three common ways to measure NaOH concentration. The least accurate is by sensing conductivity using conductive probes immersed in the cleaning solution. One can also do a quantitative analysis of the chemical constituents, which is reasonably accurate, but is somewhat dependent on the skill of the technician and is time-consuming and expensive. A third is tyroidal sensing, which uses an electromagnetic wave field that the cleaning solution attenuates in a repeatable way as the NaOH concentration increases. The strength of the wave indicates the NaOH concentration.

Some of the contaminants are solids that cause at least two types of problems. They are abrasive, so when passing through spray orifices of cleaning heads, they enlarge the orifices. The enlarged orifices (negatively) affect the velocity of the jet of cleaning solution flowing from the orifice.

Secondly, the solid contaminants may aggregate and solidify, creating what is informally referred to as “beer stones.” These beer stones can obstruct and eventually totally block fluid passages, particularly the small passages in heat exchangers, which are important elements of every ethanol plant.

These problems require periodic maintenance shutdowns of ethanol plants to replace the deteriorated components. As one might expect, shutdowns for whatever reason reduce the economic efficiency of the plant. Since an ethanol plant is expensive, these periodic shutdowns cause significant reduction in the plant's profitability.

For all these reasons, current ethanol production technology is still in a developmental phase. Solving these problems will substantially improve the economic viability of ethanol as an alternative fuel for vehicles.

### BRIEF DESCRIPTION OF THE INVENTION

One aspect of the invention addresses what the inventors find to be a significant problem with setting the NaOH concentration: that contaminants in the used cleaning solution affect the measurement of the NaOH concentration. Some of these contaminants affect the measurement accuracy for the NaOH concentration. For example, some of these contaminants are dissolved metals other than sodium that add a component of conductivity to the cleaning solution.

To address these problems, the invention in its simplest form comprises a system for reconstituting or recycling cleaning solution after use to clean one or more fermentation tanks in an ethanol production facility. To clean a fermentation tank, cleaning solution is pumped into the fermentation tank after the fermentation liquids resulting from completion of a fermentation stage are removed, and before a new fermentation stage or cycle begins.

The system comprises a tank for holding cleaning solution, and having a cleaning solution inlet port and an outlet port. A pump for circulating the cleaning solution has an inlet port and an outlet port, with the inlet port in fluid communication with the tank's outlet port. The term “fluid communication” means that cleaning solution can flow between the two indicated ports or other elements.

A filter has an inlet port in fluid communication with the pump's outlet port, and has an outlet port in fluid communication with the tank's cleaning solution inlet port. A sensor element in fluid communication with the filter's outlet port provides a condition signal indicating the concentration of the cleaning agent in the cleaning solution at the filter's outlet port.

A more sophisticated form of the invention includes a controller receiving the condition signal. The controller provides a cleaning agent valve control signal having a value based on the value of the condition signal.

An electrically controlled cleaning agent valve connects a source of concentrated cleaning agent to the tank and receives the cleaning agent valve control signal. The cleaning agent valve opens and closes responsive to the value in the cleaning agent valve control signal. Thus, if the concentration of the cleaning agent in the cleaning solution is too low, the condition signal indicates this to the controller, which then provides a cleaning agent control signal that opens the cleaning agent valve for a period of time, allowing concentrated cleaning agent to flow into the tank.

The pump runs continuously during the time the cleaning agent valve is open and afterwards as well, to thoroughly mix the concentrated cleaning agent with the cleaning solution. Such continuous pumping also allows the system to accurately maintain the cleaning solution temperature if this is desirable.

Some versions of the system include a duct that injects the concentrated cleaning agent into the tank below the surface of the cleaning solution within the tank. After the cleaning agent valve has been open for an interval, the valve is closed for another, typically longer interval, to allow thorough mixing of the concentrated cleaning agent with the cleaning solution.

### BRIEF DESCRIPTION OF THE INVENTION

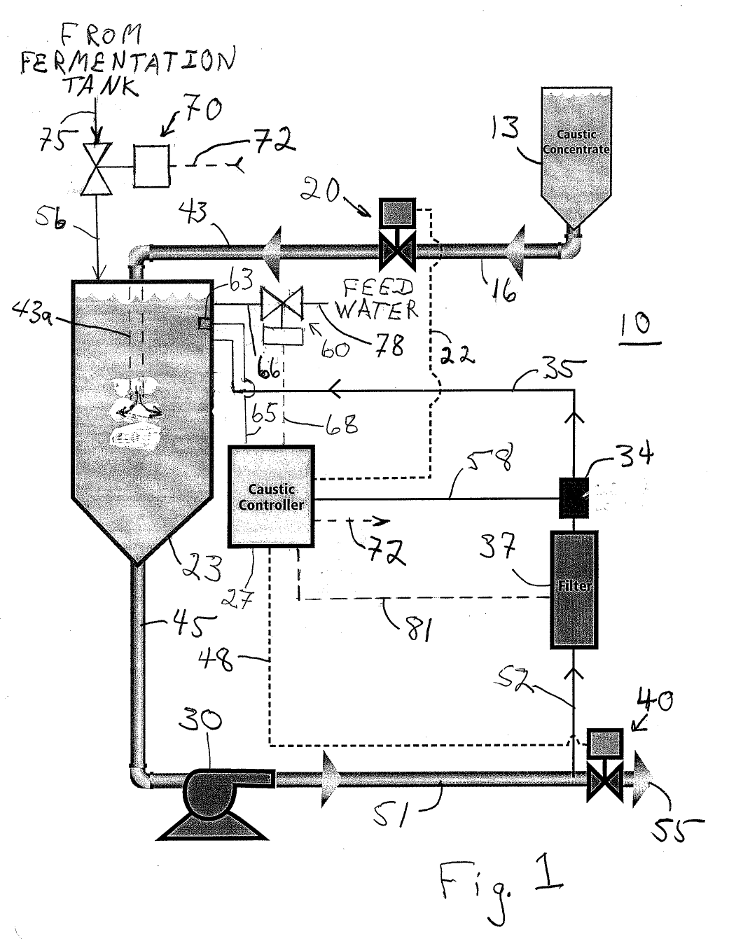

FIG. 1 is a block diagram of a preferred embodiment of a system for cleaning and reconstituting a cleaning solution for ethanol fermentation tanks.

### DESCRIPTION OF THE PREFERRED EMBODIMENTS

The block diagram of FIG. 1 shows a preferred embodiment for a cleaning solution maintenance system 10 that recycles and reconstitutes cleaning solution for an ethanol plant. System 10 comprises a subsystem of an ethanol production system. System 10 may be mounted on a trailer or other movable base.

The cleaning solution comprises a cleaning agent diluted with water. The cleaning agent typically is sodium hydroxide (NaOH) but other types of cleaning agents may be successful.

A basic version of system 10 includes a main tank 23 for holding the cleaning solution. Tank 23 has an outlet port that a duct 45 connects to an inlet port of a pump 30. (The term “duct” refers hereafter to a pipe, hose, or other liquid conduit.) Pump 30 has an outlet port connected to a fermentation tank through a duct 51, an electrically operated valve 40 and an outlet connection 55. Opening valve 40 allows pump 30 to pump cleaning solution to the fermentation tank. An electrically operated valve 70 opens to allow a return pump, not shown, to return the cleaning solution from the fermentation tank to tank 23 through a connector duct 75 and an inlet duct 56.

Closing valve 40 allows pump 30 to pump cleaning solution from tank 23 to a filter 37 through duct 52. Filter 37 removes the contaminants carried in the cleaning solution and previously washed from the fermentation tank in the ethanol plant.

A preferred filter 37 design uses a spring-loaded cleaning disc that travels up and down inside a cylindrical filter medium to remove collected contaminants. One such commercially available filter is the Ronningen-Petter DCF-800 and DCF-1600 Twin mechanically cleaned filters presently available from Eaton Corp., 9151 Shaver road, Portage, Mich. 49024. Web-based information about the DCF is presently available at this URL: http://www.ronningen-petter.com/Ethanol-CIP-Fluids.asp. This information is incorporated by reference into this application document.

A sensing element 34 receives cleaning solution flowing from filter 37 and measures or detects the level of some parameter or characteristic of the cleaning solution. Sensing element 34 provides on a path 58, a condition signal that indicates the level of this parameter or characteristic of the cleaning solution. Cleaning solution flows from sensing element 34 through a duct 35 to the top of tank 23.

Typically, this measured parameter is the concentration of the cleaning agent in the cleaning solution, but the condition signal may indicate the level of a different parameter, or even several parameters. Temperature and the level of fiber concentration, sediment, or dissolved contaminants are other possible cleaning solution parameters that particular types of a sensing element 34 might measure.

Measuring freshly filtered cleaning solution improves the accuracy of the level of the measured parameter, at least where NaOH concentration is the measured parameter. In addition, the constant circulation of the cleaning solution from tank 23 through filter 37 and back to tank 23 stirs the cleaning solution so that the concentration of the various constituents of the cleaning solution are uniform regardless of the type of active cleaning constituents in the cleaning solution.

A preferred sensing element 34 for measuring liquid conductivity has a tyroidal flow-through design, with the liquid flowing through the sensor. One such commercially available sensor is designated the 871FT Series of “Non-Invasive Sanitary and Industrial Flow-Through Conductivity Sensors available from The Foxboro Company, 33 Commercial Street, Foxboro, Minn. 02035-2099. Web-based information about the 871FT series is presently available at this URL: http://www.foxboro.com/us/eng/products/instrumentation/echemanalytical/electrodelessconctivity/models/871FT+Sensors.htm. This information is incorporated by reference into this application document.

The condition signal may in a very simple system, be used by an operator for manually controlling the measured parameter of the cleaning solution. For example, if the condition signal indicates the concentration of cleaning agent present in the cleaning solution, the operator can add water or concentrated cleaning agent to set the concentration of the cleaning agent in the cleaning solution to a desired value. If the condition signal measures contaminants dissolved in the cleaning solution, the condition signal level may indicate to the operator that the cleaning solution must circulate through filter 37 for a longer period before reuse, or cannot be reconditioned for further use.

The preferred system 10 shown in FIG. 1 operates in a more automated manner than the simple system just described. The quantitative measurements of the cleaning solution characteristic that preferred versions of sensing element 34 provide, permit more automated control of this cleaning solution characteristic. Human control of certain of these functions is also possible, depending on the structure of the ethanol plant involved and the degree of automatic operation desired.

System 10 operates under the control of a controller 27. Controller 27 may comprise any of the various microprocessor-based devices commonly used for industrial control. Controller 27 receives status signals indicating system 10 performance, such as the condition signal on path 58 from sensor 34, and sends control signals to various valves and other system 10 components that direct flow of the cleaning solution as required to implement the process for cleaning the fermentation tank and reconstituting the cleaning solution.

In this preferred system 10, a tank 13 holds concentrated cleaning solution. Opening an electrically controlled cleaning agent valve 20 allows concentrated cleaning solution to flow into tank 23 through ducts 16 and 43. Valve 20 opens and closes responsive to the state of a cleaning agent valve control signal controller 27 provides on path 22.

In case the concentration of the cleaning solution in tank 63 is too high for one reason or another, or the fluid level in tank 23 is too low, system 10 can add water to tank 23. An electrically-operated valve 60 opens and closes responsive to a control signal that controller 27 provides on path 68. When valve 60 is open, water available at a duct 78 flows through valve 60 and a duct 66 to tank 23.

Controller 27 also manages flow of cleaning solution between tank 23 and the fermentation tank. After fermentation is complete and the fermented liquid has been pumped to the distillation section of the ethanol system, the fermentation tank is cleaned and disinfected using cleaning solution from tank 23.

During startup of system 10 and after tank 23 is emptied because the cleaning solution in tank 23 can no longer be reconstituted, controller 27 sends signals to open both valves 20 and 60 to prepare a fresh volume of cleaning solution. This may occur during a fermentation cycle so no time is lost. Controller 27 holds valve 40 closed during this cleaning solution preparation phase with a closure signal on path 48.

During the cleaning solution preparation phase, pump 30 runs constantly to mix the cleaning solution in tank 23. Because the volume of cleaning solution in tank 23 is quite large, thorough mixing may require that pump 30 circulate the cleaning solution for a substantial period.

Sensor 34 provides a signal on path 58 indicating the concentration of the cleaning solution. Controller 27 opens or closes valve 20 based on the indicated concentration of the cleaning solution, to maintain the proper concentration of the cleaning solution.

A tank level sensor 63 provides a signal on path 65 that specifies the amount of liquid in tank 23. Once the liquid in tank 23 reaches its proper level, controller 27 provides a signal that closes valve 60 to prevent overfilling of tank 23, and a signal that closes valve 20 to maintain the proper cleaning solution concentration.

Preferably, duct 43 includes an extension 43a that empties the concentrated cleaning agent into the cleaning solution well below sensor 63. Injecting concentrated cleaning agent below the surface of the cleaning solution, speeds mixing of the concentrated cleaning agent into the cleaning solution.

When preparing fresh cleaning solution, in general controller 27 should hold valve 20 open only for relatively short periods when adding cleaning agent to the cleaning solution. After valve 20 has been open for a period that may increase cleaning solution concentration by approximately 1%, controller 27 should close valve 20 for a longer period to allow circulation through pump 30 to mix the cleaning agent with the cleaning solution.

After the cleaning solution has been prepared, pump 30 continues to run to cycle cleaning solution through filter 37 and sensor 34. This allows controller 27 to continually receive accurate values of the cleaning solution parameters that sensor 34 monitors, and to change parameters that are not optimal. So for example, temperature of the cleaning solution may be controlled at the same time that cleaning agent concentration in the cleaning solution is controlled.

Since the circulation of cleaning solution through tank 23, pump 30, filter 37, and the various ducts connecting these elements mixes the concentrated cleaning agent with the cleaning solution, the design of all these elements should avoid any dead spots where mixing may proceed slowly. Accordingly, some designs may benefit from returning freshly filtered cleaning solution in duct 35 to near the top of tank 23, or even above the level sensor 63. In this way, additional mixing of the concentrated cleaning agent and the cleaning solution itself may occur within tank 23.

When the time to pump cleaning solution to the fermentation tank arrives, controller 27 sends a control signal on path 48 to valve 40 to open valve 40. With valve 40 open, pump 30 pumps cleaning solution to the fermentation tank. After the proper amount of cleaning solution has flowed to the fermentation tank, controller 27 sets the signal on path 48 to close valve 40.

After an appropriate time interval for the cleaning operation in the fermentation tank or possibly some other criterion, controller 27 sends a control signal on path 72 to valve 70. The pump for returning the cleaning solution to tank 23 then pumps the now-contaminated cleaning solution back to tank 23 through ducts 75 and 56. After nearly all the cleaning solution has flowed to tank 23, controller 27 sets the signal on path 72 to close valve 70.

Flushing or rinsing the fermentation tank follows to remove remaining cleaning solution from the fermentation tank and prepare the fermentation tank for another batch of mash. This requires setting valves to direct feed water in duct 78 to the fermentation tanks that have been just cleaned, and then to drain the water used for rinsing. These operations may be done manually or under control of controller 27, depending on the sophistication of the ethanol plant.

Once the used cleaning solution has been pumped from the fermentation tank to tank 23, the cleaning solution is then reconstituted. Reconstitution includes restoring of the proper concentration of cleaning agent in the cleaning solution. Controller 27 monitors the signal on path 58 that indicates the concentration of cleaning agent in the cleaning solution.

When the concentration of the cleaning agent is too low, controller 27 provides a signal on path 22 that opens valve 20, to allow concentrated cleaning agent to flow into tank 23. Pump 30 runs continuously to circulate the cleaning solution from tank 23 through filter 37 and sensor 34 and back to tank 23. This circulation assures thorough mixing of cleaning agent in the cleaning solution and continues filtering of the cleaning solution. Controller 27 monitors the signal on path 58 that indicates the concentration of the cleaning agent in the cleaning solution.

As mentioned some types of preferred filters 37 require periodic cleaning. This cleaning may be in the nature of a backflush, or may involve mechanical brushing or scraping. Controller 27 may initiate cleaning events using a cleaning control signal on path 81 to filter 37. Controller 27 may issue the cleaning control signal at scheduled times or after a certain number of fermentation tank cleaning events. Or each filter cleaning event may occur whenever fermentation tank cleaning occurs, and no cleaning solution is in tank 23.

As mentioned above, the concentrated cleaning agent preferably flows into tank 23 well below the surface of the cleaning solution. This assures that the cleaning agent quickly mixes with the cleaning solution so that the cleaning agent concentration sensed by sensor 34 is as accurate as possible, or at least is inaccurate for only a short time.

This process continues for each fermentation cycle until the cleaning solution reconstitution is no longer possible or economical. At this point, the cleaning solution in tank 23 is discarded. Controller 27 then opens valves 20 and 60 to allow water and concentrated cleaning agent to flow into tank 23 to form a fresh batch of cleaning solution.

What is claimed is:

1. A system useful for reconstituting cleaning solution of the type comprising a solution of a cleaning agent and water intended for cleaning fermentation tanks in an ethanol production facility, said cleaning solution for pumping into a fermentation tank after the fermentation liquids resulting from completion of a fermentation stage are removed, and before a new fermentation stage begins, comprising:
a) a tank for holding cleaning solution, and having a cleaning solution inlet port and an outlet port;
b) a pump with an inlet port and an outlet port, with the inlet port in fluid communication with the tank's outlet port;
c) a filter with an inlet port in fluid communication with the pump's outlet port, and with an outlet port in fluid communication with the tank's cleaning solution inlet port; and
d) a sensor element in fluid communication with the filter's outlet port, said sensor providing a condition signal indicating the concentration of the cleaning agent in the cleaning solution at the filter's outlet port.

2. The system of claim 1, including:
a) a controller receiving the condition signal, and providing a cleaning agent valve control signal having a value based on the value of the condition signal;
b) a source of concentrated cleaning agent; and
c) a cleaning agent valve connecting the source of concentrated cleaning agent to the tank, and receiving the cleaning agent valve control signal, said cleaning agent valve opening and closing responsive to the value in the cleaning agent valve control signal.

3. The system of claim 2, including a duct connecting the cleaning agent valve to an inlet located within and below the top of the tank, to provide for mixing of concentrated cleaning agent with cleaning solution present in the tank.

4. The system of claim 2, wherein the controller provides a feed water valve control signal having a value based on the value of the condition signal;
b) a source of feed water; and
c) a feed water valve connecting the source of concentration cleaning agent to the tank, and receiving the feed water valve control signal, said feed water valve opening and closing responsive to the value in the feed water valve control signal.

5. The system of claim 4, including a cleaning solution level sensor within the tank, and providing a cleaning solution level signal to the controller, and wherein the controller provides a cleaning agent valve control signal and a feed water valve control signal respectively closing the cleaning agent and feed water valves.

6. The system of claim 2, wherein the tank's cleaning solution inlet port is located near the top of the tank.

7. The system of claim 2, wherein the filter includes a cylindrical medium having a spring-loaded cleaning disc inside the medium.

8. The system of claim 2, wherein the sensor element comprises a conductivity sensor of the tyroidal flow-through type.

9. The system of claim 1, wherein the filter includes a cylindrical medium having a spring-loaded cleaning disc inside the medium.

10. The system of claim 1, wherein the sensor element comprises a conductivity sensor of the tyroidal flow-through type.
